(19) United States
(12) Patent Application Publication
(10) Pub. No.: US 2024/0182317 A1
(43) Pub. Date: Jun. 6, 2024

(54) Lithium Recovery From Spodumene

(71) Applicant: RIO TINTO IRON AND TITANIUM CANADA INC., Sorel-Tracy (CA)

(72) Inventors: Mathieu Fillion, Sorel-Tracy (CA); Jean Giroux, Sorel-Tracy (CA); Stéphane Hubert, Sorel-Tracy (CA)

(21) Appl. No.: 18/284,935

(22) PCT Filed: Feb. 23, 2022
(86) PCT No.: PCT/CA2022/050253

§ 371 Date: Sep. 29, 2023

Related U.S. Application Data
(60) Provisional application No. 63/167,851, filed on Mar. 30, 2021.

(51) Int. Cl. C01D 15/08; C01D 15/02; C22B 1/02; C22B 1/24; C22B 3/22; C22B 3/44; C22B 26/12; H01M 4/48

(52) U.S. Cl. CPC C01D 15/08; C01D 15/02; C22B 1/02; C22B 1/2406; C22B 3/22; C22B 3/44; C22B 26/12; H01M 4/48; C01P 2006/40

(57) ABSTRACT

The present disclosure relates to a method of producing a lithium concentrate from a calcined ore comprising spodumene particles and other mineral particles. The spodumene particles are selectively screened from the calcined ore to obtain the lithium concentrate. The spodumene particles have a beta crystal structure and the other mineral particles have a crystal structure substantially similar prior to and after calcination.

### CROSS-REFERENCE TO RELATED APPLICATIONS

The present application claims priority from U.S. provisional Patent Application Ser. No. 63/167,851 filed on Mar. 30, 2021 and herewith incorporated in its entirety.

### TECHNICAL FIELD

The present disclosure generally relates to the field of lithium recovery from spodumene ore.

### BACKGROUND

As the global demand for lithium continues to grow, there is an increasing pressure for the extraction of lithium from ores such as spodumene. In the recovery of lithium from spodumene, spodumene concentration is usually performed by flotation or a combination of flotation and dense media separation. After the concentration step, spodumene concentrate is usually calcined to allow lithium extraction using conventional hydrometallurgical processes such as sulfuric acid leaching.

The flotation process requires many steps to achieve satisfactory metallurgical performance: crushing, ore sorting, fine grinding, fines removal, conditioning, mica removal (if needed), spodumene flotation (in multiple steps), magnetic separation, filtration and calcination. Given the complexity and numerous steps needed, lithium recovery in this process is generally less than 80%. Furthermore, the use of chemical reagents complicates the residue disposal. Dense media separation is another spodumene concentration method, but it is not applicable to all spodumene deposits, and recovery by this method is typically below 50%.

Therefore, improvements in the recovery of lithium from spodumene ore are desired.

### SUMMARY

There is provided a method of lithium recovery from spodumene by selectively screening calcined ore particles. The calcined ore particles comprises spodumene particles and other minerals. The spodumene particles containing lithium are separated from the other minerals by selective screening based on particle size, optionally crystal structure, thereby yielding a lithium concentrate. The lithium concentrate can then be used to obtain one or more lithium salts.

In one aspect there is provided a method of producing a lithium concentrate from a calcined ore comprising spodumene particles and other mineral particles, the method comprising selectively screening the spodumene particles from the calcined ore to obtain the lithium concentrate, wherein the spodumene particles have a beta crystal structure and the other mineral particles have a crystal structure substantially similar prior to and after calcination.

In one embodiment the particles of the lithium concentrate have a size below about 300 μm. In one embodiment screening comprises passing the calcined ore through a 25-300 μm mesh. In one embodiment the lithium concentrate comprises at least about 3% of Li₂O. In one embodiment the other mineral particles comprise less than about 2% Li₂O. In one embodiment selectively screening comprises vibratory screening, air classification, cyclone sizing or any other means of separation by size. In one embodiment prior to selectively screening, selective spodumene grinding and/or milling is performed. In one embodiment, the crushed ore is classified into coarse and fine particles. In a further embodiment, the coarse particles have a size larger than 850 μm. In another embodiment, the coarse particles have a size smaller than 15 mm. in a further embodiment, the fine particles have a size smaller than 850 μm.

In one embodiment, ore particles are calcined at a temperature ranging from about 950° C. to about 1 100° C. to obtain the calcined ore. In one embodiment, prior to selectively screening, a degree of fragilization of the spodumene particles is determined. In one embodiment, the degree of fragilization is determined with visual inspection or a size distribution analysis. In one embodiment a lithium salt is obtained from the lithium concentrate. In one embodiment the lithium salt is LiOH, Li₂O, and/or Li₂CO₃. In one embodiment the method is free of acid leaching.

In one aspect, there is provided a lithium concentrate comprising selectively screened spodumene particles, wherein the particles of the lithium concentrate have a beta crystal structure and a size below about 300 μm. In one embodiment, the selectively screened spodumene particles comprise lithium, aluminium, silicon, and oxygen.

In one embodiment, the lithium concentrate comprises at least 3% Li₂O. In one embodiment, the lithium concentrate is free of chemical reagents.

In one embodiment, the lithium concentrate is obtained according to the methods of the present disclosure.

In a further aspect there is provided a process for producing battery grade lithium salt, the method comprising (i) obtaining a lithium concentrate described herein or obtained by the method described herein; (ii) mixing the lithium concentrate with a metal carbonate to form a digested lithium compound; and (iii) obtaining battery grade lithium salt from the digested lithium compound.

Many further features and combinations thereof concerning the present improvements will appear to those skilled in the art following a reading of the instant disclosure.

### DESCRIPTION OF THE DRAWINGS

FIG. 1 is a flowchart of a method of producing a lithium concentrate according to an embodiment of the present disclosure.

FIG. 2 is a flowchart of a method of producing a lithium salt (LiOH) from a lithium concentrate according to an embodiment of the present disclosure.

FIG. 3 is a flowchart of a method of producing a lithium salt (Li₂CO₃) from a lithium concentrate according to an embodiment of the present disclosure.

FIG. 4 is a flowchart of an exemplary method of producing LiOH or Li₂CO₃.

FIG. 5 is a scanning electron microscopy image of ore particles before calcination (scale bar 100 μm, X100, 20 kV).

FIG. 6 is a scanning electron microscopy image of ore particles after calcination (scale bar 100 μm, X100, 20 kV).

### DETAILED DESCRIPTION

The methods according to the present disclosure seek to obtain a lithium concentrate allowing an increase in lithium recovery and/or reduce the environmental footprint associated with the recovery process. In some embodiments, the methods according to the present disclosure can advantageously limit or eliminate the use of chemicals (e.g. sulfuric acid for acid leaching) as well as limit the total ore tonnage (for example by up to 100%) that must be treated by flotation to obtain such lithium concentrate.

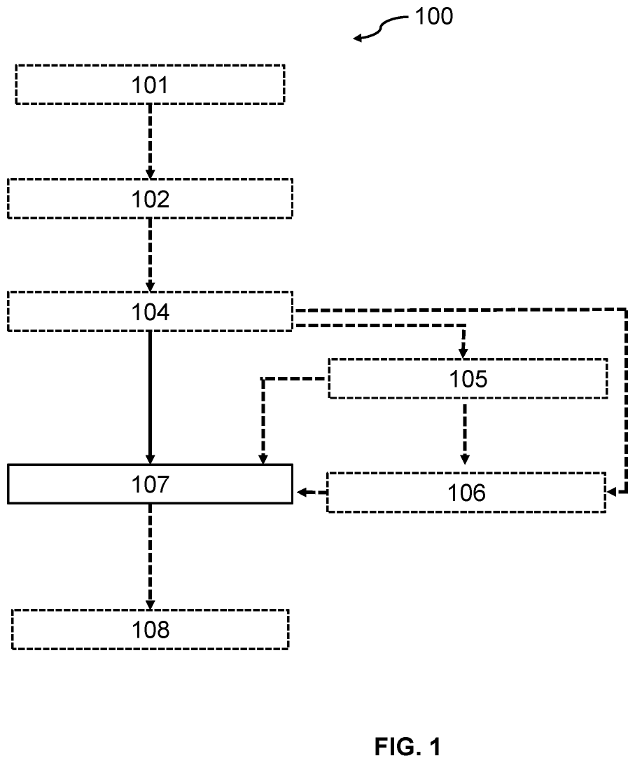

Making reference to FIG. 1, there is provided a method 100 of producing a lithium concentrate. An ore comprising spodumene (as well as other minerals) may first be obtained 101. The ore can be a run of mine (ROM) ore comprising spodumene or spodumene concentrate. Spodumene comprises the majority of the lithium present in the ore. In some examples, at least 95% of the lithium in the ore is contained in spodumene. The ROM ore can be crushed to reduce the size of the ROM ore if necessary (not shown on FIG. 1). For example, the ROM ore can be crushed to a have a size lower than about 15 mm, in some embodiments between about 6 to about 15 mm. Crushing the ROM allows for the dissociation of spodumene grains that may be associated with other minerals. As such, in some embodiments, the method comprises crushing the ROM ore to obtain crushed ore particles having a size lower than 15 mm and in some embodiments, lower than 6 mm. In further embodiments, the method comprises sorting the crushed ore to obtain fine ore particles and coarse ore particles.

The method provided herein is based on the selective screening of lithium containing particles in a calcined ore. A calcination step, is conducted on coarse ore and/or fines particles derived from crushed ore. As such, in the method of the present disclosure, a step of providing coarse ore particles or, alternatively obtaining the fine ore particles can optionally be provided. In some embodiments, the coarse ore particles can be obtained by separating 102 them from the fine ore particles. In one embodiment, the term “fine ore particle” as used herein refers to an ore particle that has a size of less than about 850 μm, less than about 700 μm, less than about 600 μm, less than about 500 μm, less than about 400 μm, or less than about 300 μm. In an embodiment, the fine ore particle can have a size equal to or less than 300 μm. In a particular example, the fine ore particle can have an average size of 500 μm. The term “coarse ore particle” as used herein refers to an ore particle that has a size larger than the fine ore particles. For example, the coarse particle can have a size of at least about 300 μm, at least about 400 μm, at least about 500 μm, at least about 600 μm, at least about 700 μm, or at least about 850 μm or higher. In an embodiment, the large ore particle can have a size equal to or higher than 850 μm. In some embodiments, the separation 102 seeks to select coarse ore particles having a size between 850 and 7,000 μm. The separation 102 can be performed with a suitable screen or mesh. In some embodiments, the separation 102 can be performed by using a 850 μm mesh. Alternatively, the separation 102 can be performed by air classification. In one embodiment, prior to calcination, crushed ore is split by screening or by any other sizing method into coarse and fine particles. Preferably, the coarse particles have a size larger than 850 μm. More preferably, the coarse particles have a size smaller than 15 mm. Preferably, fine particles have a size smaller than 850 μm.

The separation 102 provides coarse and fines particles suitable for calcination 104.

Separating the fine and coarse particles prior to calcination may increase the gangue/spodumene separation efficiency of the coarse particles. This may result in a higher spodumene concentration (higher concentrate grade). Separating fines from coarse particles and calcining them separately may allow for a process adjusted to the mineralogy of the particular spodumene ore, thus allowing for optimal lithium grade and recovery in the concentrate.

The method of the present disclosure can include providing a calcined ore and, optionally calcining 104 the coarse and fine particles to provide the calcined ore. Calcination 104 can be performed to modify the crystal structure of the spodumene particles which later allows for a selective screening 107. Spodumene is naturally occurring in its alpha crystalline structure which is relatively stable (and in some embodiments resistant to chemical degradation). To allow the selective screening of lithium-containing particles (spodumene) from the calcined ore, a change in spodumene crystalline structure from alpha to beta phase is sought during calcination 104.

The calcination of spodumene ore can be done with any energy source including, but not limited to: natural gas, propane, heavy oil, biomass, and electricity. The calcination can be performed by direct or indirect heating with any calcination equipment including but not limited to: directly heated rotary kiln, indirectly heated rotary kiln, fluidized bed or any other similar equipment. Electricity powered calcination equipment can be heated by electric resistance, electric arc plasma torch, or by any other similar device.

In some embodiments, the calcination 104 modifies the crystal structure (from alpha to beta) of at least 90%, 91%, 92%, 93%, 94%, 95%, 96%, 97%, 98%, 99% or more of the spodumene calcined particles. In one particular embodiment, the totality (i.e. 100%) of the crystal structure of calcined spodumene particles is in the beta phase. More specifically, in some embodiments, the crystal structure of spodumene expands and fragilizes during calcination 104. The term “fragilize” as used herein is defined as the transition of spodumene particles from an alpha to a beta crystal structure. The term “fragilize” may be further defined as having a compromised structural integrity (for example having one or more fractures) in the spodumene particles.

As it will be explained below, the method relies on a selective screening of spodumene particles, which is possible because other minerals present in the coarse and fine ore particles that are being submitted to calcination 104 do not substantially change their crystal structure. The other (non spodumene) minerals are not significantly fragilized by calcination 104 since they substantially maintain the same crystal structure. Coarse and fines particles may not be calcined together since they require a different mesh size to separate spodumene particles from other minerals after the calcination step.

In one embodiment, the calcination 104 is performed at a temperature of between about 950 and between about 1 100° C., between about 975 and about 1 080° C., between about 1 000 and about 1 070° C., between about 1 030 and about 1 060° C., between about 950 and about 1 060° C., between about 950 and 1 050° C., or about 1 050° C. It is understood that calcining below the temperature of about 950° C. would not induce the change in the crystal structure of spodumene and calcining above the temperature of about 1100° C. may soften and melt (liquefy) some other minerals in the ore. Thus in one embodiment, the calcination temperature is at most about 1 100° C. In some embodiments, the calcination is performed at a temperature of about 1 050° C. In some embodiments, the calcination 104 is performed at atmospheric pressure. In further embodiments, the calcination is performed during a time period between about 5 minutes and about 60 minutes. The calcination 104 yields a calcined ore that comprises calcined spodumene and other minerals. In some embodiments, the method comprises calcining the coarse ore particles. In further embodiments, the method comprises calcining the coarse ore particles and the fine ore particles.

Coarse particles may be calcined independently of the fines particles because fine particles require a different screening size after calcination. An ultra-fine fraction (for example, a size ranging from 0-106 μm) from the fine particles can be removed by screening or air classification prior calcination to enhance the concentrate grade. Depending on the exact mineralogy of the spodumene ore, separating ultra-fine from fine particles prior to calcination may increase the gangue/spodumene separation efficiency of fine particles resulting in a higher spodumene concentration (higher concentrate grade).

Spodumene ore feeding the process can have any Li₂O grade and can be run of mine, pre-concentrated or concentrated ore from process. Example of pre-concentration/concentration process may include ore sorting, dense media separation, magnetic separation, or other. Calcining fines separately from coarse ore particles may also allow for more energy-efficient calcination (fines require less calcination time).

Processing the fine particles using the same process (calcination and classification) enables recovery of lithium using the same equipment (without flotation). This may result in lower capital costs and a less complex process.

Following calcination 104, optionally, a degree of fragilization of calcined spodumene can be determined 105. The term “degree of fragilization” as used herein can refer to a measure of the susceptibility of a particle to lose at least a portion of its structural integrity (e.g. break). The degree of fragilization is also an indication of the suitability of particles to be subjected to a selective screening 107.

Determining the degree of fragilization may be done at predetermined time intervals during operation to control/adjust the process.

If the particles are not suitable for the selective screening based on their degree of fragilization then further grinding (selective spodumene grinding) and/or milling 106 is indicated and can be performed to increase fragilization. The degree of fragilization can be determined from the crystal structure of particles based on a direct or indirect analysis. For example a direct analysis can be performed by observing the crystal structure by microscopy. In another example, an indirect analysis can be performed by macroscopic visual inspection or size distribution analysis to determine the degree of fragilization. If the degree of fragilization of a calcined spodumene is below a pre-determined threshold, grinding and/or milling 106 is performed to bring the degree of fragilization equal to or above the pre-determined threshold. In one example, the threshold can be that the spodumene particles have a size about 4 times smaller than the other (non spodumene) mineral particles. In further embodiments, the threshold can be that the spodumene particles have a size about 4.25 times smaller, 4.5 times smaller, 5 times smaller, or more when compared to the size of the other (non spodumene) mineral particles. Once the degree of fragilization is above the pre-determined threshold the calcined spodumene can be subject to the step of selectively screening 107. If the degree of fragilization of a calcined spodumene is determined to be above a pre-determined threshold of fragilization then the calcined ore can be directly provided for the selective screening 107. Thus in some embodiments, the degree of fragilization can additionally be determined after the grinding and/or milling 106 to assess whether the grinding and/or milling was sufficient. When warranted, the grinding and/or milling can be performed before or concurrently with the selective screening 107. Examples of grinding include but are not limited to: adding steel/ceramic balls on the screening deck to fragilize spodumene particles, performing an attrition before screening, performing a soft ball milling prior to screening, and combinations thereof. Accordingly, in some embodiments, the method further comprises determining 105 a degree of fragilization of calcined spodumene particles. In further embodiments, the method further comprises grinding and/or milling 106 the calcined ore prior to or during the selectively screening 107.

Without wishing to be bound by theory, it is expected that within the same ore deposit, the spodumene fragilization degree under the same calcination parameters will not vary substantially. Thus, in one embodiment, the degree of fragilization can be determined in the first batch of calcined spodumene from a given ore deposit and applied to the remainder of calcined spodumene obtained from the given ore deposit without having to determine the fragilization again. As such, in some embodiments, the method comprises directly grinding and/or milling 106 spodumene after calcination 104. In additional embodiments, the determination 105 can be used to modify the calcination parameters (increase in residence time or temperature) so as to provide fragilized spodumene particles.

The method of the present disclosure provides selective screening 107 to separate the calcined spodumene particles from the other minerals that may be present in the ore and therefore to obtain a lithium concentrate. The selective screening can be performed to obtained particles having a size below about 300 μm. The selective screening can be conducted with a suitable screen (or mesh) for example having an opening (aperture) size of between equal to or higher than about 25 μm, equal to or lower than about 300 μm and in some specific embodiments, between about 45 to about 300 μm. In some embodiments, the selectively screened spodumene particles have a size of less than 300 μm, less than 290 μm, less than 280 μm, less than 270 μm, less than 260 μm, or less than 250 μm. In one embodiment, the selective screening 107 comprises the use of a vibratory screen, air classifier, an air classifier, cyclone sizing or any other means of separation by size. The vibration and other similar means can be used to facilitate and/or accelerate the screening. In some embodiments, the lithium concentrate obtained after the selective screening 107 comprise at least about 3% Li₂O. In some embodiments, the other mineral particles of the calcined ore (that are not retained by the selective screening) comprise less than 2% Li₂O. Since the lithium concentrate is not obtained with the use of chemical additives (e.g., flotation) but instead by physical separation (i.e. selectively screening 107) thus, in one embodiment, the method of producing a lithium concentrate according to the present disclosure is free of chemical reagents and contamination (for example flotation reagents). The absence of chemical contaminants reduces the environmental footprint of the method of the present disclosure when compared methods of the prior art that include flotation. Indeed, the residue waste generated by the present method can be easily disposed since they can be free of harmful reagents in contrast to the prior art.

The method of the present disclosure advantageously achieves a lithium recovery of at least 80%, at least 85%, or at least 87% in the lithium concentrate. The lithium recovery represents the amount of lithium contained in the concentrate divided by the amount of lithium contained in the ROM ore.

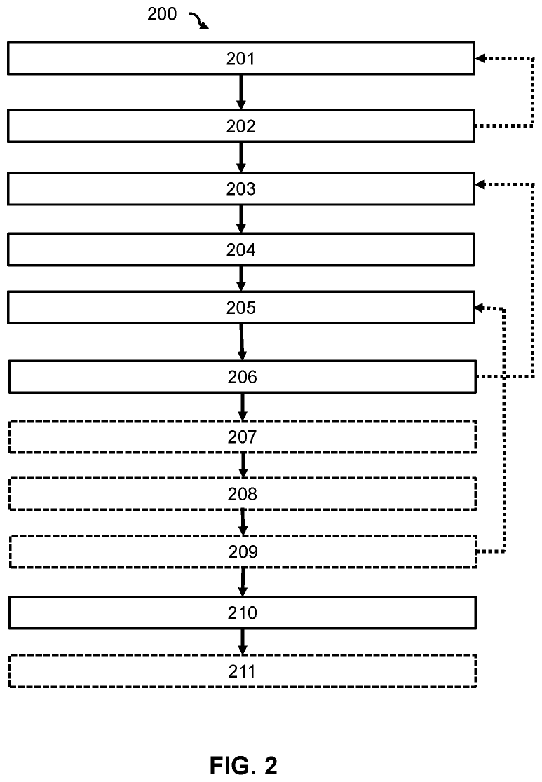

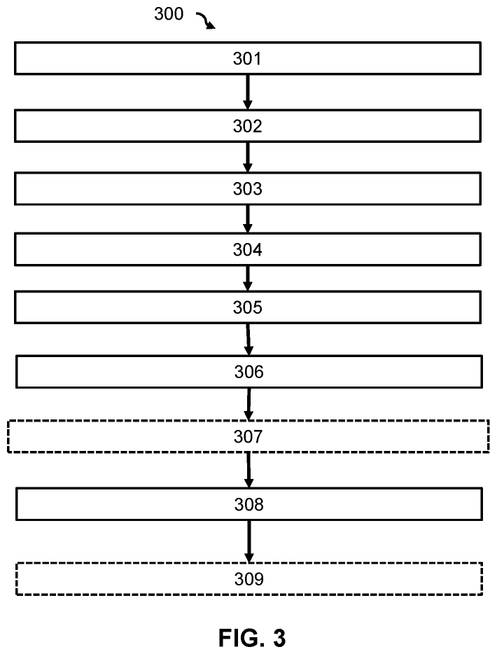

The selective screening 107 generates a lithium concentrate which can be used to obtain a lithium salt. A lithium salt is obtained 108 from the lithium concentrate by any suitable method. The lithium salt can be a commercially desirable salt, for example LiOH, Li₂O, and/or Li₂CO₃. Accordingly, in some embodiments, the method comprises obtaining a lithium salt from the lithium concentrate. In some embodiments, these methods can produce battery grade lithium carbonate with less than 0.5% impurities content. Exemplary methods of obtaining the lithium salt are shown in FIGS. 2 and 3.

In one example, a hydrometallurgical process is performed to obtain LiOH from the lithium concentrate. Making reference to FIG. 2 there is provided a process 200 of making LiOH from the lithium concentrate. The lithium concentrate is first autoclaved 201 to obtain a slurry. Autoclaving 201 can be performed for example by adding an additive salt (e.g. a sodium salt) and an aqueous phase (e.g., water). The autoclaving 201 can for example be performed at a temperature of between about 200 and 240ºC and at a pressure of between about 320 to between about 360 psi (i.e. 2.2-2.48 MPa). The autoclaving 201 can be performed under agitation. The autoclaving 201 can be performed for at least 60 minutes. The slurry obtained from the autoclave can be filtered 202 to obtain a filtrate that comprises lithium and a residue that contains the additive salt and aluminosilicates. The autoclaving 201 and filtering 202 may be repeated by adding the residues or retentate of the filtering 202 back into the autoclave to increase the yield of extracted lithium. The retentate can then be converted 203 into a suspension, namely a mixture of LiOH and CaO (for example a slurry) by adding water and CaO to have the lithium in soluble form. The mixture of LiOH and CaO can then filtered 204 to obtain a LiOH filtrate that comprises LiOH. The LiOH is then precipitated 205 by crystallization to obtain LiOH crystals suspended in solution. In one embodiment, the precipitation 205 is performed by varying pressure (e.g. vacuum) and/or temperature to evaporate the liquid components of the filtrate. LiOH crystals can then be separated 206 from the solution by centrifugation or other similar means of solid/liquid separation. By optionally dissolving 207 the LiOH crystals (e.g., in a dissolving tank) the LiOH crystals can be subjected to further steps of precipitation (crystallization) 208 and separation 209 to recover more lithium and reduce the impurities content. The precipitated LiOH crystals are then dried 210 to obtain dry LiOH crystals which can then be optionally packaged 211. In one example, the drying 210 can be performed at a temperature of between 100 and 150° C. or until all free water is removed and lithium hydroxide is in a monohydrate form. The packaging 211 can be, for example, a packaged air-tight bag.

Now turning to FIG. 3, in another example, there is provided a process 300 of making Li₂CO₃ from the lithium concentrate. Similarly as in FIG. 2, the lithium concentrated is autoclaved 301 to obtain a slurry. The autoclaving 301 can be performed under the same conditions as the autoclaving 201. Autoclaving 301 can be performed for example by adding an additive salt (e.g., a sodium salt) and an aqueous phase (e.g., water). The autoclaving 301 can for example be performed at a temperature of between about 200 and 240ºC and at a pressure of between about 320 to between about 360 psi (i.e. 2.2-2.48 MPa). The autoclaving 301 can be performed under agitation. The autoclaving 301 can be performed for at least 60 minutes. After the digestion by autoclaving 301, the slurry can be sent to a bicarbonation tank for bicarbonating 302 to obtain a LiHCO₃ containing solution. The bicarbonation step 302 can be operated with, for example, a CO₂ injection at between 140 and 160 psi (i.e. 0.965-1.1 MPa) at room temperature (e.g. 150 psi/1.03 MPa and 20° C.). The bicarbonation 302 transforms moderately soluble lithium carbonate into more soluble lithium bicarbonate in solution (e.g., solubilized slurry). The solution is then filtered 303 in order to remove aluminosilicates residue. The filtrate is heated 304 to 95° ° C. to remove CO₂ which may be recycled to the bicarbonation step 302. The CO₂ removal driven by heating 304 further converts lithium bicarbonate to lithium carbonate which has a lower solubility and precipitates 305. The precipitated lithium carbonate can then be separated 306 from the liquid phase with any suitable means for example a centrifugation. Depending on initial feedstock quality, a second bicarbonation step 307 can optionally be performed to remove impurities. Removing impurities 307 may thus comprise a second precipitation and centrifugation with the same conditions as steps 305 and 306. Furthermore removing impurities 307 can optionally further include an ion exchange such as an ion exchange chromatography to further improve the purity. Finally, the crystals can be dried 308 and packaged 309.

The fabrication of a lithium ion battery is contemplated within the present disclosure. A lithium salt (e.g. LiOH or Li₂CO₃) can be obtained by the methods of the present disclosure and included in the battery. For example, the lithium can be included in an electrode of the battery. Methods of fabricating batteries are well known to the person skilled in the art.

### Example

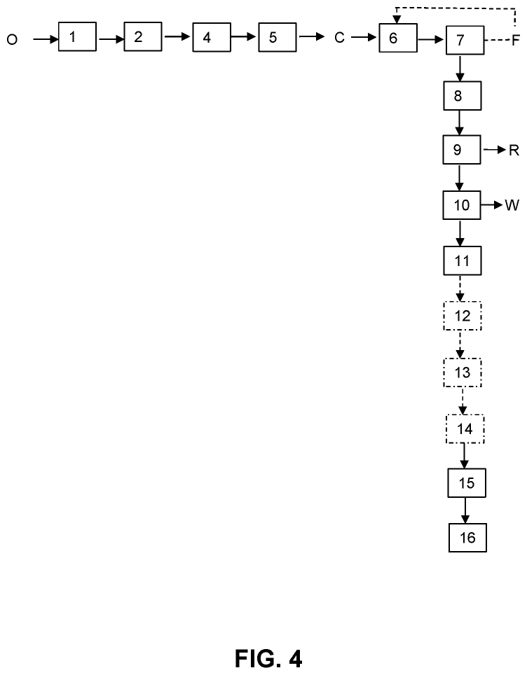

A lithium concentrate was produced following an exemplary method illustrated 50 in FIG. 4. First, run of mine (ROM) ore (O ton) was crushed 1 until the adequate liberation degree of spodumene was reached, specifically to a maximal size of from 6 to 15 mm, to thereby obtain crushed ore particles. The crushed ore particles were screened 2 to separate coarse ore particles (0.9 ton) from fine ore particles (0.1 ton). The fine ore particles having a size of less than 850 μm (e.g. 300-800 μm) with a total weight 0.1 ton were separated by screening 2 to calcine them separately from the coarse particles.

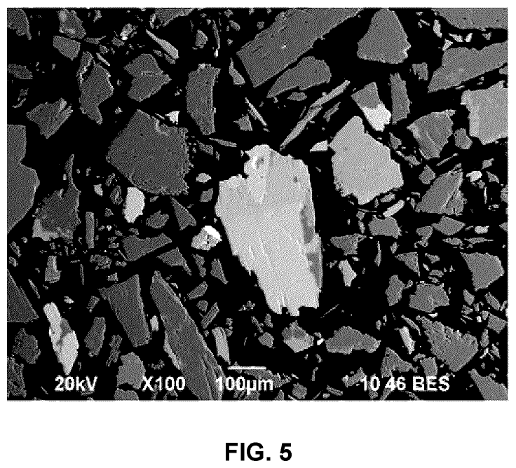

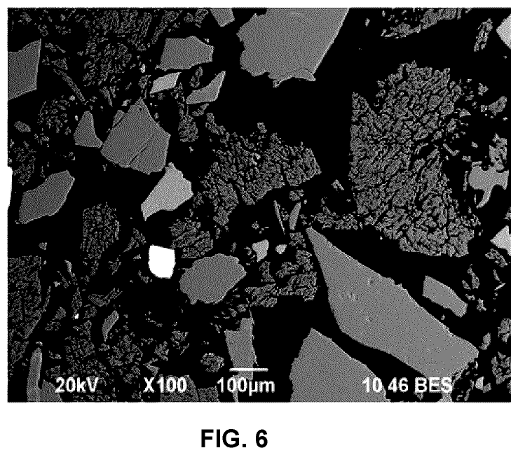

The coarse ore particles were calcined 4 by heating at 1050° C. under atmospheric pressure. The crystal structure expanded and fragilized the spodumene grains thereby yielding calcined ore. Other minerals were not significantly fragilized since they kept the same crystal structure. FIG. 5 shows an electron microscopy image of the crystal structure of the coarse ore particles (prior to calcination) and FIG. 6 shows an electron microscopy image of the crystal structure of the calcined ore. As shown in FIG. 5, the spodumene of the coarse ore particles was in its alpha crystal structure prior to calcination. As shown in FIG. 6, the spodumene of the calcined ore fragilized to its beta crystal structure. In contrast, the crystal structure of the other minerals present in the coarse ore particles remained unchanged during calcination. Due to spodumene fragilization occurring during calcination 4, spodumene grains broke or were easy to break in smaller grains. The spodumene grains were separated from other coarser mineral grains by screening 5 screen to obtain a lithium concentrate C. The lithium concentrate C obtained following the screening 5 had a total weight of 0.2 ton and the discarded coarse residues were 0.72 ton.

For lithium hydroxide production, the slurry exiting the autoclave 6 was filtered 7. The filtrate F containing Na₂CO₃ and a portion of Li₂CO₃ was recycled to the autoclave while the residue containing solid Li₂CO₃ and aluminosilicates was subject to a conversion 8 to convert Li₂CO₃ to highly soluble LiOH with CaO. The slurry was filtered 9. The residue of the filtration 9 was a reject R containing aluminosilicates and CaCO₃ (from the reaction between CaO and Li₂CO₃). The filtrate contained LiOH and was sent to a first crystallizer 10 where water W was evaporated under vacuum in order to precipitate LiOH. LiOH crystals were separated from the remaining solution with a centrifuging 11. Depending on initial feedstock quality, a dissolution step was optionally performed 12 and a second crystallization to decrease impurities level 13 and centrifugation 14 followed. Finally, the product was dried 15 and packaged for shipping 16 (LiOH(H₂O)). This process produced battery grade lithium hydroxide monohydrate with less than 0.5% impurities content.

To obtain a lithium salt, the lithium concentrate as submitted to a hydrometallurgical process. More specifically, the lithium concentrate was mixed with Na₂CO₃ and water in an agitated autoclave 6 for 60 minutes or more at 180-220° C. at 340 psi (equivalent to 2.34 MPa). The lithium in the spodumene structure was substituted by aqueous sodium ions during the reaction. As a result, lithium formed lithium carbonate which has a moderate solubility. Lithium carbonate was mainly present as a precipitate.

More specifically, two tests were performed. In the first test, a ROM head sample with 1.25% Li₂O was upgraded by calcination and screening at 212 μm achieving 89% lithium recovery at 5.45% Li₂O grade. The Li recovery represents the amount of lithium contained in the concentrate divided by the amount of Li contained in the ROM sample. In the second test, a ROM head sample with 1.9% Li₂O sample was upgraded by calcination & screening at 212 μm achieving 89% lithium recovery at 6.0% Li₂O grade. The results are summarized in Table 1 below after obtaining a lithium salt (Li₂O) by hydrometallurgical processing. The elemental content of the lithium concentrate was determined and is shown in Table 2.

TABLE 1
Concentration results obtained using two different ores.
Concentration results on +850 um ore with 212 um screening

| | Head sample | Concentrate | Li recovery |
|---|---|---|---|
| | grade (% Li2O) | grade (% Li2O) | (%) |
| Coarse ore test 1 | 1.25 | 5.45 | 89 |
| Coarse ore test 2 | 1.9 | 6 | 89 |

TABLE 2
Elemental analysis of a lithium concentrate

| | |
|---|---|
| [symbol] : | [symbol] |
| [symbol] : | [symbol] |
| [symbol] : | [symbol] |
| [symbol] | [symbol] |
| [symbol] | [symbol] |
| [symbol] | [symbol] |
| [symbol] | [symbol] mg/kg |
| [symbol] | [symbol] mg/kg |
| [symbol] | [symbol] mg/kg |
| [symbol] | [symbol] mg/kg |
| [symbol] | [symbol] mg/kg |
| [symbol] | [symbol] mg/kg |
| [symbol] | [symbol] mg/kg |
| [symbol] | [symbol] mg/kg |
| [symbol] | [symbol] mg/kg |
| [symbol] | [symbol] mg/kg |
| [symbol] | [symbol] mg/kg |
| [symbol] | [symbol] mg/kg |
| [symbol] | [symbol] mg/kg |
| [symbol] | [symbol] mg/kg |
| [symbol] | [symbol] mg/kg |
| [symbol] | [symbol] mg/kg |

[symbol]

indicates data missing or illegible when filed

Additionally, three other tests are described below. In Table 3, the concentration of coarse particles is illustrated on an another ore source (different from that presented in Tables 1 and 2). Table 4 illustrates the concentration process performance on pre-concentrated ore (coarse fraction). Table 5 illustrates coarse and fines valorization with the concentration process.

TABLE 3
Concentration results on a run of
mine sample from a third ore body

| | Mass | Grade | Li recovery |
|---|---|---|---|
| Name | % | % Li2O | % |
| Feed | 100 | 2.52 | 100 |
| Fines | 10 | 1.36 | 5 |
| Concentrate | 29 | 7.52 | 86 |
| Reject | 61 | 0.37 | 9 |

TABLE 4
Concentration results on concentrated ore (dense
media separation) (same ore body than Table 3)

| % | Head sample | Conc | Reject |
|---|---|---|---|
| Mass yield | 100 | 88.1 | 11.9 |
| Li yield | 100 | 97.7 | 2.3 |
| Li2O | 6.7 | 7.6 | 1.3 |
| Al | 7.97 | 8.19 | 7.68 |
| Fe | 0.5 | 0.35 | 0.39 |
| K | 0.28 | 0.03 | 1.82 |
| Mn | 0.06 | 0.06 | 0.05 |
| Na | 0.32 | 0.19 | 1.4 |
| P | 0.04 | 0.01 | 0.08 |
| Ti | 0.03 | 0.03 | 0.04 |

TABLE 5
Example of coarse and fine particles valorization
using the developed process

| | Mass | Concentrate grade | Li recovery |
|---|---|---|---|
| Size fraction | % | % Li₂O | % |
| Coarse (0.8-8 mm) | 80 | 6 | 89 |
| Fine (0-0.8 mm) | 20 | 6 | 64 |
| Combined (0-8 mm) | 100 | 6 | 84 |

While the invention has been described in connection with specific embodiments thereof, it will be understood that the scope of the claims should not be limited by the preferred embodiments set forth in the examples, but should be given the broadest interpretation consistent with the description as a whole.

1. A method of producing a lithium concentrate from a calcined ore comprising spodumene particles and other mineral particles, the method comprising selectively screening the spodumene particles from the calcined ore to obtain the lithium concentrate, wherein the spodumene particles have a beta crystal structure and the other mineral particles have a crystal structure substantially similar prior to and after calcination.

2. The method of claim 1, wherein the particles of the lithium concentrate have a size below about 300 μm.

3. The method of claim 1, wherein screening comprises passing the calcined ore through a 25-300 μm mesh.

4. The method of claim 1, wherein the lithium concentrate comprises at least about 3% of Li₂O.

5. The method of claim 1, wherein the other mineral particles comprise less than about 2% Li₂O.

6. The method of claim 1, wherein selectively screening comprises vibratory screening, air classification, cyclone sizing or any other means of separation by size.

7. The method of claim 1 further comprising, prior to selectively screening, grinding and/or milling the calcined ore producing crushed ore.

8. The method of claim 7, wherein the crushed ore is classified into coarse and fine particles.

9. The method of claim 8, wherein the coarse particles have a size larger than 850 μm.

10. The method of claim 8, wherein the coarse particles have a size smaller than 15 mm.

11. The method of claim 8, wherein the fine particles have a size smaller than 850 μm.

12. The method of claim 1, further comprising calcining coarse and fines ore particles at a temperature ranging from about 950 to about 1 100° C. to obtain the calcined ore.

13. The method of claim 1, further comprising calcining coarse and fines ore particles separately to obtain the calcined ore.

14. The method of claim 12, wherein the coarse ore particles have a size of at least about 300 μm

15. The method of claim 1, further comprising, prior to selectively screening, determining a degree of fragilization of the spodumene particles.

16. The method of claim 15, comprising determining the degree of fragilization by visual inspection or size distribution analysis.

17. The method of claim 1, being free of chemical reagent.

18. The method of claim 1, further comprising obtaining a lithium salt from the lithium concentrate.

19. The method of claim 17, wherein the lithium salt is LiOH, Li₂O, and/or Li₂CO₃.

20. A lithium concentrate comprising selectively screened spodumene particles, wherein the particles of the lithium concentrate have:
a beta crystal structure; and
a size below about 300 μm.

21. The lithium concentrate of claim 20, being obtained from the method of claim 1.

22-24. (canceled)

25. A process for producing battery grade lithium salt, the method comprising (i) obtaining a lithium concentrate as defined in claim 20; (ii) mixing the lithium concentrate with a sodium salt to form a digested lithium compound; and (iii) obtaining battery grade lithium salt from the digested lithium compound.

26. A process for producing battery grade lithium salt, the method comprising (i) obtaining a lithium concentrate obtained by the method as defined in claim 1; (ii) mixing the lithium concentrate with a sodium salt to form a digested lithium compound; and (iii) obtaining battery grade lithium salt from the digested lithium compound.
